(19) United States
(12) Patent Application Publication
(10) Pub. No.: US 2016/0128167 A1
(43) Pub. Date: May 5, 2016

(54) METHOD AND SYSTEM FOR WIRELESS MUSIC-MODULATED LIGHTING USING LED LIGHTING DEVICES

(71) Applicant: SENGLED OPTOELECTRONICS CO., LTD., Zhejiang (CN)

(72) Inventors: CHAOQUN SUN, Tongxiang (CN); XIA WANG, Tongxiang (CN); JINXIANG SHEN, Tongxiang (CN)

(73) Assignee: SENGLED OPTOELECTRONICS CO., LTD., Tongxiang (CN)

(21) Appl. No.: 14/893,270

(22) PCT Filed: Apr. 27, 2015
(86) PCT No.: PCT/CN2015/077491

§ 371 Date: Nov. 23, 2015

(30) Foreign Application Priority Data
May 5, 2014 (CN) 2014-10187447.4

(51) Int. Cl. H05B 37/02; H05B 33/08

(52) U.S. Cl. CPC H05B 37/0236; H05B 37/0272; H05B 33/0815; H05B 33/0872; H05B 33/0854

(57) ABSTRACT

The present disclosure provides a wireless music-modulated lighting method using LED lighting devices and a system thereof. The system comprises a main LED lighting device including a power drive module, a wireless RF module and a wireless audio module; and secondary LED lighting devices including a power drive module and a wireless audio module; a wireless router and a smart terminal. The main LED lighting device and the smart terminal access a wireless network through the wireless router. Audio signals sent by the smart terminal are transmitted to the main LED lighting device through the wireless router, and to the secondary LED lighting devices through the wireless audio module. The lighting devices are provided with a control unit configured to output different PWM or PFM light-adjusting signals to the power drive module according to different music, therefore changing lighting color and color temperature of the lighting devices. The present disclosure can automatically adjust lighting atmosphere or change lighting color and color temperature of the lighting devices in real time, therefore improve user experience.

### CROSS-REFERENCES TO RELATED APPLICATIONS

This application is a national stage patent application of PCT application No. PCT/CN2015/077491, filed on Apr. 27, 2015.This application claims the priority of Chinese Patent Application No. 201410187447.4, entitled “Method and System for Wireless Music-Modulated Lighting Using LED Lighting Devices,” filed on May 5, 2014, the entire content of which is incorporated herein by reference.

### FIELD OF THE DISCLOSURE

The present disclosure relates to the field of LED lighting technologies and wireless technologies and, more particularly, relates to a wireless light adjustment method according to music played using the lighting devices and a system thereof.

### BACKGROUND

LED technologies provide many advantages including high energy efficiency, eco-friendliness, controllable lighting, durable quality, long lifespan, etc. LED technologies have been widely adopted in various lighting applications, such as lighting in public places, office lighting, indoor lighting, etc. As a speaker system may be integrated with LED lighting devices, through wireless technologies, smart terminals can share audio signals with lighting devices for broadcasting. However, in existing systems that combines wireless speakers and lighting devices, when playing audio signals, the LED lighting devices cannot provide multiple desired functions, such as: accommodating music scenario changes, automatically adjusting lighting atmosphere according to music style, changing lighting colors and flashing in real-time, etc.

The disclosed method and system are directed to solve one or more problems set forth above and other problems.

### BRIEF SUMMARY OF THE DISCLOSURE

The present disclosure overcomes the problems set forth above and provides an energy-efficient and eco-friendly wireless music-modulated lighting method for automatically adjusting lighting color and color temperature of lighting devices according to music being played and a system thereof

One aspect of the present disclosure provides a wireless music-modulated lighting method using LED lighting devices, including the following steps.

Step 1: The system provides a main LED lighting device and a secondary LED lighting device. The main LED lighting device may include a power drive module, a wireless radio frequency (RF) module and a wireless audio module. The secondary LED lighting device may include a power drive module and a wireless audio module.

Step 2: The main LED lighting device connects to a wireless router through the built-in wireless RF module, thereby accessing a wireless network.

Step 3: A smart terminal connects to the wireless router, and audio signals to the main LED lighting device. The audio signals are then transmitted through the wireless audio module of the main LED lighting device to the secondary LED lighting device for playing.

Step 4: The main LED lighting device and the secondary LED lighting device are each provided with a control unit. According to different music being played, the control unit can generate and output different pulse-width modulation (PWM) or pulse-frequency modulation (PFM) light-adjusting signals to the power drive module, therefore changing lighting color and color temperature of the lighting devices according to the music.

Another aspect of the present disclosure provides a wireless music-modulated lighting method using LED lighting devices, including the following steps.

Step 1: The system includes a main LED lighting device and a secondary LED lighting device. The main LED lighting device includes a power drive module, a wireless RF module and a wireless audio module. The secondary LED lighting device may include a power drive module and a wireless audio module.

Step 2: The main LED lighting device receives audio signals from a smart terminal. The audio signals are then transmitted through the wireless audio module of the main LED lighting device to the secondary LED lighting devices for playing.

Step 3: The main LED lighting device and the secondary LED lighting device are each provided with a control unit. According to different music being played, the control unit can generate and output different PWM or PFM light-adjusting signals to the power drive module, therefore changing lighting color and color temperature of the lighting devices according to the music.

Another aspect of the present disclosure provides a wireless music-modulated lighting system, including a main LED lighting device, a secondary LED lighting device, a wireless router and a smart terminal. The main LED lighting device may include a power drive module, a wireless RF module and a wireless audio module. The secondary LED lighting device may include a power drive module and a wireless audio module. The main LED lighting device and the smart terminal may access a wireless network through the wireless router. Audio signals sent by the smart terminal may be transmitted to the main LED lighting device through the wireless router, and then be transmitted through the wireless audio module of the main LED lighting device to the secondary LED lighting device for playing. The main LED lighting device and the secondary LED lighting device are each provided with a control unit. According to different music being played, the control unit can generate and output different PWM or PFM light-adjusting signals to the power drive module, therefore changing lighting color and color temperature of the lighting devices according to the music.

Another aspect of the present disclosure provides a wireless music-modulated lighting system, including a main LED lighting device, a secondary LED lighting device and a smart terminal. The main LED lighting device may include a power drive module, a wireless RF module and a wireless audio module. The secondary LED lighting device may include a power drive module and a wireless audio module. The main LED lighting device may connect to the smart terminal through the built-in wireless RF module. The smart terminal may send audio signals to the main LED lighting device. The audio signals are then transmitted through the wireless audio module of the main LED lighting device to the secondary LED lighting device for playing. The main LED lighting device and the secondary LED lighting device are each provided with a control unit. According to different music being played, the control unit can generate and output different PWM or PFM light-adjusting signals to the power drive module, therefore changing lighting color and color temperature of the lighting devices according to the music.

Comparing to the prior art, the disclosed wireless music-modulated method and system can change lighting atmosphere according to music styles and music pieces being played by adjusting lighting color and color temperature of the lighting devices, therefore providing a more desirable user experience.

### BRIEF DESCRIPTION OF THE DRAWINGS

The following drawings are merely examples for illustrative purposes according to various disclosed embodiments and are not intended to limit the scope of the present disclosure.

FIG. 1 is a schematic structure diagram illustrating an exemplary main LED lighting device consistent with the present disclosure;

FIG. 2 is a schematic structure diagram illustrating an exemplary secondary

LED lighting device consistent with the present disclosure;

FIG. 3 is a structure diagram illustrating an exemplary wireless music-modulated lighting system consistent with a first disclosed embodiment; and

FIG. 4 is a structure diagram illustrating an exemplary wireless music-modulated lighting system consistent with a second disclosed embodiment.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

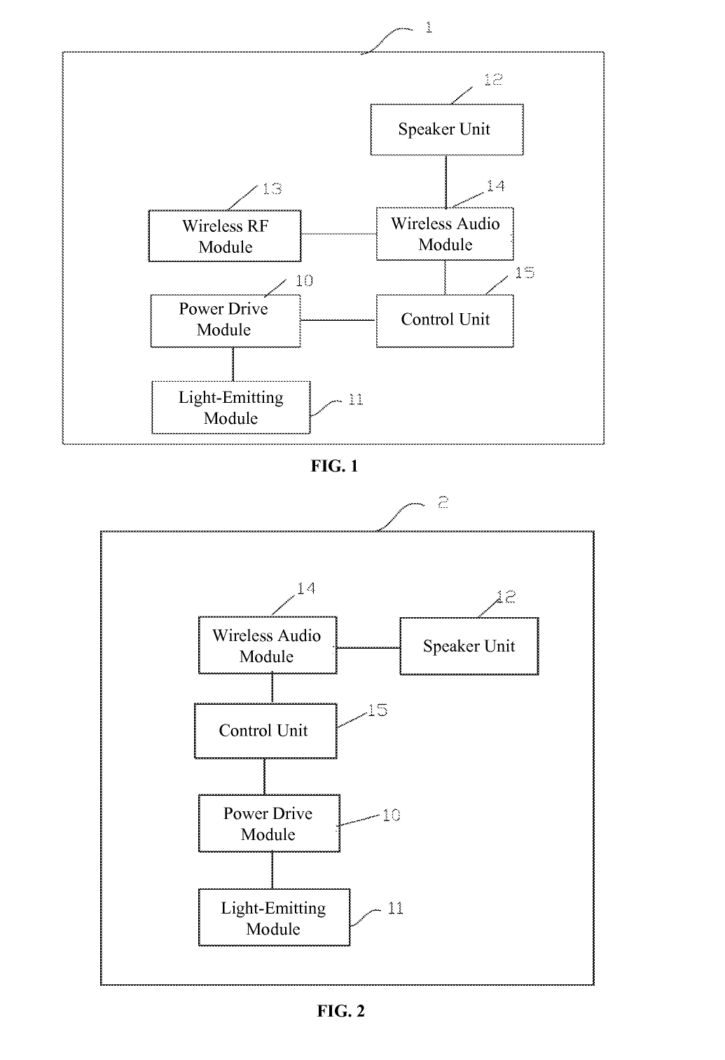

As shown in FIGS. 1 and 2, the present disclosure provides lighting devices.

The lighting devices may include a main LED lighting device 1 and a secondary LED lighting device 2. The main LED lighting device 1 and the secondary LED lighting device 2 may have structures similar to certain common lighting devices on the market, providing a power drive module 10 and a light-emitting module 11 that connects to the power drive module 10. Further, the main LED lighting device 1 and the secondary LED lighting device 2 may both include a control unit 15 and a speaker unit (an electro-acoustic conversion unit) 12 for audio play. The difference between the main LED lighting device 1 and the secondary LED lighting device 2 is that the main LED lighting device 1 further includes a wireless radio frequency (RF) module 13 and a wireless audio module 14, while the secondary LED lighting device 2 may further include just a wireless audio module 14. The wireless audio module 14 of the main LED lighting device 1 and the wireless audio module 14 of the secondary LED lighting device 2 can communicate with each other.

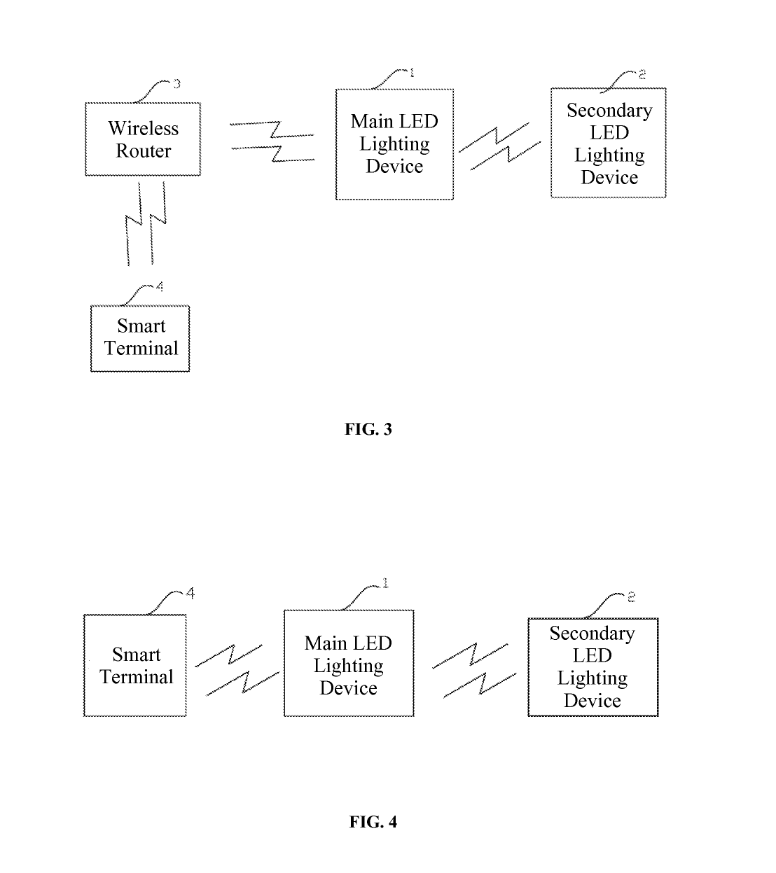

FIG. 3 is a structure diagram illustrating an exemplary wireless music-modulated lighting system consistent with a first disclosed embodiment. As shown in FIGS. 1, 2 and 3, the disclosed wireless music-modulated lighting system includes at least one main LED lighting device 1, at least one LED lighting device 2, a wireless router 3 and a smart terminal 4. The wireless RF module 13 in the main LED lighting device 1 may conform to a search mechanism of Digital Living Network Alliance (DLNA) or Airplay. That is, the wireless RF module 13 may access the same wireless router 3 as that of smart terminal 4, therefore maintaining communication with smart terminal 4. The main LED lighting device 1 and smart terminal 4 can access a wireless network through the wireless router 3, while the secondary LED lighting device 2 may not connect to the wireless router 3. Audio signals sent by smart terminal 4 may be transmitted through the wireless router 3 to the main LED lighting device 1, and then be transmitted to the secondary LED lighting device 2. The secondary LED lighting device 2 may provide feedback information to the smart terminal 4 through the main LED lighting device 1, therefore wirelessly synchronizing with the smart terminal 4 and retrieving the to-be-played audio signals in the lighting devices that supports DLNA or Airplay.

In addition, to accommodate changes of the music being played, the main LED lighting device 1 and the secondary LED lighting device 2 may each provide a control unit 15. According to different music being played, the control unit 15 can generate and output different pulse-width modulation (PWM) or pulse-frequency modulation (PFM) light-adjusting signals to the power drive module 10, therefore changing lighting color and/or color temperature of the lighting devices according to the music.

The implementation of changing lighting color and/or color temperature of the lighting devices according to music may include two options. One option is to provide a preset configuration in the lighting devices, which controls lighting colors, and color temperatures corresponding to different music styles. When the smart terminal sends to-be-played audio signals to the lighting devices, according to different music styles being played, the control unit 15 in the lighting devices may generate and output different PWM or PFM light-adjusting signals to the power drive module 10, therefore automatically changing the lighting color and color temperature of the lighting devices. Another option is that when the smart terminal sends the to-be-played audio signals to the lighting devices, the control unit 15 may receive and buffer music data in real time, such as volume and frequency spectrum data. According to the received real-time music data, the control unit 15 may generate and output different PWM or PFM light-adjusting signals to the power drive module, therefore changing the lighting color and color temperature of the lighting devices in real time.

FIG. 4 is a structure diagram illustrating an exemplary wireless music-modulated lighting system consistent with a second disclosed embodiment. As shown in FIGS. 1, 2, and 4, the disclosed wireless music-modulated lighting system may include at least one main LED lighting device 1, at least one secondary LED lighting device 2 and a smart terminal 4. The main LED lighting device 1 may include a wireless RF module 13 and a wireless audio module 14. The secondary LED lighting devices may include a wireless audio module 14. In this embodiment, the wireless RF module 13 in the main LED lighting device 1 may be a WIFI module or a Bluetooth module. The smart terminal 4 may directly connect to the main LED lighting device 1 through WIFI signals or Bluetooth signals. The smart terminal 4 may send audio signals to the main LED lighting device 1. The audio signals are then transmitted to the secondary LED lighting device 2 through the wireless audio module 14 of the main LED lighting device 1. The secondary LED lighting device 2 may provide feedback information to the smart terminal 4 through the main LED lighting device 1. The main LED lighting device 1 and the secondary lighting device 2 may form a multi-channel wireless speaker system. Therefore, the lighting devices can play multi-channel audio signals.

Further, to accommodate scenario changes of the music being played, the main LED lighting device 1 and the secondary LED lighting device 2 may each provide a control unit 15. According to different music pieces being played, the control unit 15 can generate and output different PWM or PFM light-adjusting signals to the power drive module, therefore changing lighting color and color temperature of the lighting devices according to the music.

The implementation of changing lighting color and color temperature of the lighting devices according to music may include two options. One option is to provide a preset configuration in the lighting devices which configures lighting colors and color temperatures corresponding to different music styles. When the smart terminal 4 sends the to-be-played audio signals to the lighting devices, according to different music styles being played, the control unit 15 in the lighting devices may generate and output different PWM or PFM light-adjusting signals to the power drive module 10, therefore automatically changing the lighting color and color temperature of the lighting devices. Another option is that when the smart terminal 4 sends the to-be-played audio signals to the lighting devices, the control unit 15 may receive and buffer music data in real time, such as volume and frequency spectrum data. According to the received real-time music data, the control unit 15 may generate and output different PWM or PFM light-adjusting signals to the power drive module, therefore changing the lighting color and color temperature of the lighting devices in real time.

In the present disclosure, a number of the secondary LED lighting devices 2 may be configured according to practical needs. For example, a plurality of lighting devices may form a wireless speaker system with 2.0-channel, 2.1-channel, 4.1-channel, 5.1-channel or 7.1-channel.

In certain embodiments, the main LED lighting device and the secondary LED lighting devices may combine with one or more existing Bluetooth or wireless speakers through the wireless module to form a speaker system with more channels. For example, in a home environment, there is already a 2.1-channel wireless speaker system including one subwoofer and two satellite speakers. The main LED lighting device may connect to the existing 2.1-channel wireless speaker and three secondary LED lighting devices. The three secondary LED lighting devices may locate at different corners of the room. The audio signals may be transmitted from the main LED lighting device to the subwoofer, the two satellite speakers and the three secondary LED lighting devices, therefore forming a 5.1-channel speaker system.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

In certain embodiments consistent with the present disclosure, a user may use the smart terminal to preset a lighting adjustment program for one type of music (e.g., Jazz). For example, the smart terminal may have a defined sequence of lighting changes correspond to a piece of Jazz music. The smart terminal may transmit data to the control units of the lighting devices. When the smart terminal plays Jazz, the lighting of the LED lighting devices may be adjusted according to the pre-defined sequence.

In certain embodiments consistent with the present disclosure, a user application may also set lighting adjustment programs for other applications, such as certain computer games. For example, the user may use a smart terminal to define a lighting sequence for computer game A. During an active session of the computer game A, the lighting of the LED lighting devices may be set at a certain color/brightness level (e.g., dimmed to a certain level). The smart terminal may transmit data to the control units of the lighting devices. When the user finishes one user session of game A, the lighting of the LED lighting devices may be adjusted to a different color/brightness level (e.g., flashing or bright light). Further, when an event in game A happens in a user session (e.g., the user won bonus points), the lighting may also be adjusted to a certain color/brightness level. When a user play computer game A on the smart terminal, for example, the LED lighting may dim, flash, etc. according to various game events. Computer game A is exemplary; the smart terminal may design lighting adjustment programs for other applications in a similar manner.

In certain embodiments consistent with the present disclosure, the LED lighting devices may also provide a feedback to the speakers integrated into the lighting devices. For example, a user may play a piece of music that dims the lighting of the LED lighting devices in one room. If a second user comes into the room and turns up the brightness level of one or more of the LED lighting devices using the dimmer, the LED lighting devices may send a feedback signal to the speaker to turn down the volume of the music while increasing the brightness level. The smart terminal may also display the feedback information (e.g., “lights turned on”) on the user interface while adjusting the sound levels.

In certain embodiments consistent with the present disclosure, the LED lighting devices may also include motion sensors or other sensors. The control units may further incorporate the detected positions of users in one room when adjusting lighting levels in the room. For example, when adjusting the lighting level according to a piece of music, the control units may set the lighting around a user to be more bright (or at a warmer color, etc.) in comparison to the lighting in the corners of the room without any detected user.

Comparing to the prior art, the disclosed wireless music-modulated lighting method and system can display music changes, automatically change lighting atmosphere according to the music style being played, and change lighting color and color temperature of the lighting devices, therefore providing more desirable user experience.

What is claimed is:

A wireless music-modulated lighting method using LED lighting devices, comprising:
providing a main LED lighting device and at least one secondary LED lighting device, the main LED lighting device including a power drive module, a wireless radio frequency (RF) module and a wireless audio module, and the secondary LED lighting device including a power drive module and a wireless audio module;
connecting the main LED lighting device to a wireless router through the wireless RF module, thereby accessing a wireless network;
connecting a smart terminal to the wireless router, sending audio signals to the main LED lighting device;
transmitting the audio signals to the secondary LED lighting device through the wireless audio module of the main LED lighting device;
providing a control unit to each of the main LED lighting device and the secondary LED lighting device, wherein the control unit is configured to generate and output different pulse-width modulation (PWM) or pulse-frequency modulation (PFM) light-adjusting signals to the power drive module according to a piece of music being played; and
adjusting a lighting color or a color temperature of the lighting devices according to the music.

2. The wireless music-modulated lighting method according to claim 1, further comprising: providing feedback information, by the secondary LED lighting device, to the smart terminal through the main LED lighting device.

3. The wireless music-modulated lighting method according to claim 1, wherein:
the main LED lighting device and the secondary LED lighting device provide a preset configuration which sets corresponding lighting colors and color temperatures according to different music styles; and
when the smart terminal sends the to-be-played audio signals to the lighting devices, according to the different music styles being played, the control unit in the lighting devices generates and outputs different PWM or PFM light-adjusting signals to the power drive module, therefore automatically changing the lighting color or the color temperature of the lighting devices.

4. The wireless music-modulated lighting method according to claim 1, wherein:
when the smart terminal sends the to-be-played audio signals to the main LED lighting device and the secondary LED lighting device, the control unit receives music data in real time; and
according to the received real-time music data, the control unit generates and outputs different PWM or PFM light-adjusting signals to the power drive module, therefore changing the lighting color or color temperature of the lighting devices in real time.

5. A wireless music-modulated lighting method using LED lighting devices, comprising:
providing a main LED lighting device and a secondary LED lighting device, the main LED lighting device including a power drive module, a wireless radio frequency (RF) module and a wireless audio module, and the secondary LED lighting device including a power drive module and a wireless audio module;
receiving audio signals, by the main LED lighting device, from a smart terminal, and transmitting the audio signals to the secondary LED lighting device through the wireless audio module of the main LED lighting device;
providing a control unit to each of the main LED lighting device and the secondary LED lighting device, wherein the control unit is configured to generate and output different pulse-width modulation (PWM) or pulse-frequency modulation (PFM) light-adjusting signals to the power drive module according to a piece of music being played; and
changing a lighting color or a color temperature of the lighting devices according to the music.

6. The wireless music-modulated lighting method according to claim 5, further comprising: providing feedback information, by the secondary LED lighting device, to the smart terminal through the main LED lighting device.

7. The wireless music-modulated lighting method according to claim 5, wherein:
the lighting devices provide a preset configuration which configures corresponding lighting colors or color temperatures according to different music styles; and
when the smart terminal sends the to-be-played audio signals to the lighting devices, according to different music styles being played, the control unit in the lighting devices generates and outputs different PWM or PFM light-adjusting signals to the power drive module, therefore automatically changing the lighting color or the color temperature of the lighting devices.

8. The wireless music-modulated lighting method according to claim 5, wherein:
when the smart terminal sends the audio signals to the lighting devices, the control unit receives and stores music data in real time; and
according to the received real-time music data, the control unit generates and outputs different PWM or PFM light-adjusting signals to the power drive module, therefore changing the lighting color or color temperature of the lighting devices in real time.

9. The wireless music-modulated lighting method according to claim 5, wherein the wireless RF module in the main LED lighting device adopts a WIFI module or a Bluetooth module.

10. A wireless music-modulated lighting system, comprising:
a main LED lighting device configured to include a power drive module, a wireless radio frequency (RF) module and a wireless audio module;
a secondary LED lighting device configured to include a power drive module and a wireless audio module;
a wireless router; and
a smart terminal;
wherein:
the main LED lighting device and the smart terminal access a wireless network through the wireless router;
the smart terminal transmits audio signals to the main LED lighting device through the wireless router, and the audio signals are then transmitted to the secondary LED lighting device through the wireless audio module of the main LED lighting device;
the main LED lighting device and the secondary LED lighting device are each provided with a control unit; and
according to different music being played, the control unit generates and outputs different pulse-width modulation (PWM) or pulse-frequency modulation (PFM) light-adjusting signals to the power drive module, changing a lighting color or a color temperature of the lighting devices according to the music.

11. The wireless music-modulated lighting system according to claim 10, wherein the secondary LED lighting device provides feedback information to the smart terminal through the main LED lighting device.

12. The wireless music-modulated lighting system according to claim 10, wherein:
the lighting devices provide a preset configuration which configures corresponding lighting colors or color temperatures according to different music styles; and
when the smart terminal sends the to-be-played audio signals to the lighting devices, according to different music styles being played, the control unit in the lighting devices generates and outputs different PWM or PFM light-adjusting signals to the power drive module, therefore automatically changing the lighting color or the color temperature of the lighting devices.

13. The wireless music-modulated lighting system according to claim 10, wherein:
when the smart terminal sends the audio signals to the lighting devices, the control unit receives and stores music data in real time; and
according to the received real-time music data, the control unit generates and outputs different PWM or PFM light-adjusting signals to the power drive module, therefore changing the lighting color or color temperature of the lighting devices in real time.

14. A wireless music-modulated lighting system, comprising:
a main LED lighting device configured to include a power drive module, a wireless radio frequency (RF) module and a wireless audio module;
a secondary LED lighting device configured to include a power drive module and a wireless audio module; and
a smart terminal;
wherein:
the main LED lighting device wirelessly connects to the smart terminal through the built-in wireless RF module;
the smart terminal transmits audio signals to the main LED lighting device, and the audio signals are then transmitted through the wireless audio module of the main LED lighting device to the secondary LED lighting device for playing;
the main LED lighting device and the secondary LED lighting device are each provided with a control unit; and
according to different music being played, the control unit generates and outputs different pulse-width modulation (PWM) or pulse-frequency modulation (PFM) light-adjusting signals to the power drive module, therefore changing lighting color and color temperature of the lighting devices according to the music.

15. The wireless music-modulated lighting system according to claim 14, wherein the secondary LED lighting device provides feedback information to the smart terminal through the main LED lighting device.

16. The wireless music-modulated lighting system according to claim 14, wherein:
the lighting devices provide a preset configuration which configures corresponding lighting colors or color temperatures according to different music styles; and
when the smart terminal sends the audio signals to the lighting devices for playing, according to different music styles being played, the control unit in the lighting devices generates and outputs different PWM or PFM light-adjusting signals to the power drive module, therefore automatically changing the lighting color and the color temperature of the lighting devices.

17. The wireless music-modulated lighting system according to claim 14, wherein:
when the smart terminal sends the audio signals to the lighting devices for playing, the control unit receives and stores music data in real time; and
according to the receives real-time music data, the control unit generates and outputs different PWM or PFM light-adjusting signals to the power drive module, therefore changing the lighting color and color temperature of the lighting devices in real time.

18. The wireless music-modulated lighting system according to claim 14, wherein the wireless RF module in the main LED lighting device adopts a WIFI module or a Bluetooth module.

19. The wireless music-modulated lighting system according to claim 18, wherein the main LED lighting device and the secondary LED lighting devices combines one or more existing Bluetooth or wireless speakers through the wireless RF module to form a speaker system.

20. The wireless music-modulated lighting system according to claim 19, wherein:
the existing Bluetooth or wireless speakers include one subwoofer and two satellite speakers; and
the main LED lighting device and three secondary LED lighting devices located at different corners in the room combines with the subwoofer and the two satellite speakers, forming a 5.1-channel speaker system.
